(19) United States
(12) Patent Application Publication
(10) Pub. No.: US 2022/0238878 A1
(43) Pub. Date: Jul. 28, 2022

(54) NEGATIVE ELECTRODE FOR USE IN FLUORIDE ION SECONDARY BATTERY AND FLUORIDE ION SECONDARY BATTERY INCLUDING SAME

(71) Applicant: HONDA MOTOR CO., LTD., Tokyo (JP)

(72) Inventors: Akihisa TANAKA, Saitama (JP); Yoshiyuki MORITA, Saitama (JP)

(21) Appl. No.: 17/584,357

(22) Filed: Jan. 25, 2022

(30) Foreign Application Priority Data
Jan. 26, 2021 (JP) 2021-010575

(51) Int. Cl. H01M 4/58; H01M 10/05

(52) U.S. Cl. CPC H01M 4/582; H01M 2004/021; H01M 10/05

(57) ABSTRACT

Provided is a fluoride ion secondary battery having a capacity larger than that of a conventional one. The fluoride ion secondary battery includes a negative electrode including Li₃AlF₆ as a negative electrode active material. The content of the active material Li₃AlF₆ in the negative electrode may be 25% by mass or less. The active material Li₃AlF₆ may be in an amorphous state and may be in the form of particles with an average particle size on the order of micrometers.

This application is based on and claims the benefit of priority from Japanese Patent Application No. 2021-010575, filed on 26 Jan. 2021, the content of which is incorporated herein by reference.

### BACKGROUND OF THE INVENTION

### Field of the Invention

The present invention relates to a negative electrode for use in a fluoride ion secondary battery and to a fluoride ion secondary battery including such a negative electrode.

### Related Art

In the conventional art, fluoride ion secondary batteries are proposed using fluoride ions as carriers (see, for example, Patent Documents 1 to 6). Fluoride ion secondary batteries are expected to be superior in performance to lithium-ion secondary batteries, and have been studied in various ways in recent years.

For example, aluminum-based materials have been studied as candidates for the negative electrode active material in fluoride ion secondary batteries. In particular, aluminum fluoride has been studied for use in fluoride ion secondary batteries. Unfortunately, aluminum fluoride has a problem in that it is relatively less prone to electrochemical reactions due to its electrical insulating properties.
Patent Document 1: Japanese Unexamined Patent Application, Publication No. 2019-87403
Patent Document 2: Japanese Unexamined Patent Application, Publication No. 2017-50113
Patent Document 3: Japanese Unexamined Patent Application, Publication No. 2019-29206
Patent Document 4: Japanese Unexamined Patent Application, Publication No. 2018-206755
Patent Document 5: Japanese Unexamined Patent Application, Publication No. 2018-198130
Patent Document 6: Japanese Unexamined Patent Application, Publication No. 2018-92863

### SUMMARY OF THE INVENTION

Thus, a fluoride ion secondary battery has been provided including, as a negative electrode active material, modified AlF₃, which is a lithium metal-doped aluminum fluoride material. At present, however, such a fluoride ion secondary battery is required to have further improved characteristics. Specifically, modified AlF₃ including aluminum fluoride doped with lithium metal has relatively low ionic conductivity, and the concentration of the negative electrode active material in the negative electrode cannot be increased sufficiently, which makes it not easy to provide a battery with a large capacity.

The present invention has been made in light of the circumstances mentioned above, and an object of the present invention is to provide a fluoride ion secondary battery having a capacity larger than that of the conventional one.

(1) An aspect of the present invention is to provide a negative electrode for use in a fluoride ion secondary battery, the negative electrode including a negative electrode active material including Li₃AlF₆.

(2) The negative electrode according to aspect (1) for use in a fluoride ion secondary battery may have a negative electrode active material content of 25% by mass or less.

(3) In the negative electrode according to aspect (1) or (2) for use in a fluoride ion secondary battery, the Li₃AlF₆ may be in an amorphous state.

(4) In the negative electrode according to any one of aspects (1) to (3) for use in a fluoride ion secondary battery, the Li₃AlF₆ may be in the form of particles with an average particle size on the order of micrometers.

(5) Another aspect of the present invention is to provide a fluoride ion secondary battery including the negative electrode according to any one of aspects (1) to (4).

The present invention makes it possible to provide a fluoride ion secondary battery having a capacity larger than that of the conventional one.

### BRIEF DESCRIPTION OF THE DRAWINGS

FIG. 1 is a diagram showing a method for synthesizing Li₃AlF₆ as a negative electrode active material according to an embodiment of the present invention;

FIG. 2 is a graph showing an X-ray diffraction spectrum of Li₃AlF₆ as a negative electrode active material according to the embodiment;

FIG. 3 is a view showing the properties of Li₃AlF₆ and conventional modified AlF₃;

FIG. 4 is a diagram showing an exemplary method for producing a negative electrode according to an embodiment of the present invention for use in a fluoride ion secondary battery;

FIG. 5 is a diagram showing an exemplary method for producing a conventional negative electrode for use in a fluoride ion secondary battery;

FIG. 6 is a graph showing an NMR spectrum of Li₃AlF₆ as a negative electrode active material according to the embodiment;

FIG. 7 is a graph showing the charging and discharging curves of the negative electrode half cells of Example 1 and Comparative Example 1 for fluoride ion secondary batteries; and

FIG. 8 is a graph showing the charging and discharging curves of the negative electrode half cells of Example 2 and Comparative Example 2 for fluoride ion secondary batteries.

### DETAILED DESCRIPTION OF THE INVENTION

Hereinafter, embodiments of the present invention will be described in detail with reference to the drawings.

Negative Electrode for Use in Fluoride Ion Secondary Battery The negative electrode according to an embodiment of the present invention for use in a fluoride ion secondary battery includes Li₃AlFe₆ as a negative electrode active material. A negative electrode including Li₃AlFe₆ and being for use in a fluoride ion secondary battery has not been known so far. The negative electrode according to the embodiment for use in a fluoride ion secondary battery is characterized by including Li₃AlFe₆.

Li₃AlFe₆ functions as a negative electrode active material during charging and discharging. Specifically, Li₃AlFe₆ releases fluoride ions F⁻ during charging, and stores fluoride ions F⁻ during discharging. Li₃AlFe₆ may be synthesized, for example, as shown below.

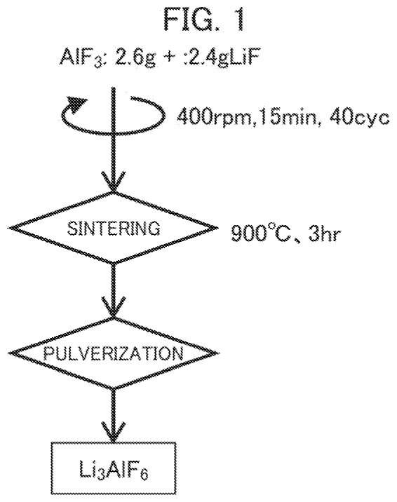

FIG. 1 is a diagram showing a method for synthesizing Li₃AlF₆ as a negative electrode active material according to an embodiment of the present invention. As shown in FIG. 1, first, LiF and AlF₃ are mixed in a molar ratio of 3:1. (LiF:AlF₃=3 mol:1 mol). In the example shown in FIG. 1, for example, 2.4 g of LiF is mixed with 2.6 g of AlF₃. Subsequently, the mixture is subjected to, for example, 40 cycles of ball milling at 400 rpm for 15 minutes and then sintered, for example, at 900° C. for 3 hours. The sintered product is pulverized to give Li₃AlF₆ as a negative electrode active material according to the embodiment.

The sintering is preferably carried out at a temperature in the range of 850° C. to 900° C. Since the raw material LiF has a melting point of 850° C., LiF and AlF₃ can be melted and uniformly mixed with each other in such a sintering temperature range. If the sintering temperature exceeds 900° C., the raw materials may evaporate and the sintered product weight may begin to decrease significantly, which is not desirable.

The sintering at a temperature in the range of 850° C. to 900° C. is preferably carried out for a time period in the range of 2 hours to 3 hours. If the sintering time period is less than 2 hours, LiF may insufficiently react with AlF₃, which is not desirable. If the sintering time period is more than 3 hours, the raw materials may evaporate so that a low yield may occur, which is not desirable.

After the sintering, the pulverization may be, for example, crushing in an agate mortar or the like. The particles resulting from the pulverization are microparticles. The microparticles are further pulverized by ball milling in the process of preparing a negative electrode material mixture powder as described later.

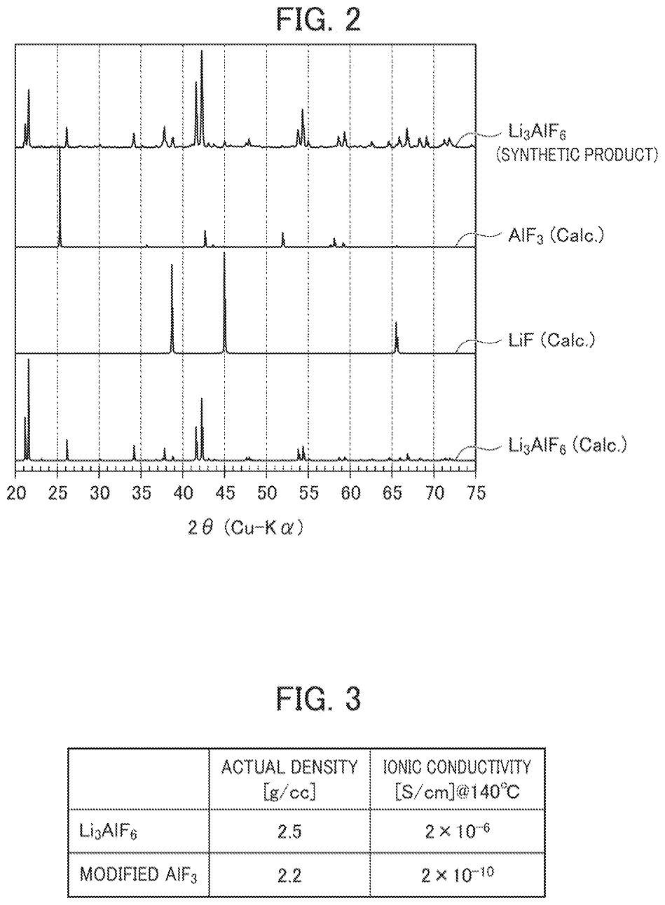

FIG. 2 is a graph showing an X-ray diffraction spectrum of Li₃AlF₆ as a negative electrode active material according to the embodiment. The graph of FIG. 2 shows the X-ray diffraction spectra of, from the top, a synthetic product obtained according to the synthesis method shown in FIG. 1, AlF₃ (theoretically calculated value), LiF (theoretically calculated value), and Li₃AlF₆ (theoretically calculated value). As shown in FIG. 2, the X-ray diffraction spectrum of the synthetic product obtained according to the synthesis method shown in FIG. 1 has Li₃AlF₆-derived peaks while the peaks derived from the raw materials AlF₃ and LiF disappear from the spectrum. This means that the X-ray diffraction spectra of FIG. 2 confirm that the synthesis method shown in FIG. 1 successfully produces Li₃AlF₆.

The negative electrode active material according to the embodiment is preferably in an amorphous state. The X-ray diffraction spectrum of FIG. 2 shows that the negative electrode active material Li₃AlF₆ as synthesized by the method described above is in a crystalline state. However, the crystalline state turns into an amorphous state in the process of producing the negative electrode according to the embodiment for use in a fluoride ion secondary battery as described later. The negative electrode active material Li₃AlF₆ as synthesized by the method described above is considered to have an unstable crystal structure, which can be destroyed and turned into an amorphous state by ball milling in the process described later. It is expected that when in such an amorphous state, the negative electrode active material Li₃AlF₆ according to the embodiment can be tightly bonded to a solid electrolyte or a conductive aid to form good boundaries.

The negative electrode according to the embodiment for use in a fluoride ion secondary battery preferably has a Li₃AlF₆ content of 25% by mass or less. In this regard, when the modified AlF₃ produced by doping aluminum fluoride with lithium metal is used according to the conventional art, the content of the modified AIF, in the conventional negative electrode for use in a fluoride ion secondary battery is up to 12.5% by mass. In contrast, the content of Li₃AlF₆ according to the embodiment in the negative electrode for use in a fluoride ion secondary battery can be increased up to 25% by mass. This means that the embodiment makes it possible to provide a battery with a capacity significantly larger than that of the conventional one.

The Li₃AlF₆, as a negative electrode active material according to the embodiment is preferably in the form of particles with an average particle size on the order of micrometers. The conventional modified AlF₃, which is a lithium metal-doped aluminum fluoride material, is in the form of particles with an average particle size on the order of nanometers. In the embodiment, however, Li₃AlF₆ as a negative electrode active material can be more densified when in the form of particles with an average particle size on the order of micrometers. This makes it possible to achieve higher ionic conductivity and to provide a battery with a larger capacity. The Li₃AlF₆ in the form of microparticles with an average particle size on the order of micrometers can be produced using AlF₃ and LiF as raw materials each in the form of microparticles with an average particle size on the order of micrometers. In contrast to the conventional modified AlF₃, the Li₃AlF₆ according to the embodiment can be further increased in particle size by the sintering step, which is carried out later.

FIG. 3 is a view showing the properties of Li₃AlF₆ and the conventional modified AlF₃ produced by doping aluminum fluoride with lithium metal. FIG. 3 shows the measured values of the densities of Li₃AlF₆ according to the embodiment and the modified AlF₃ proposed in the conventional art. FIG. 3 also shows their ionic conductivities at 140° C. where fluoride ion secondary batteries are assumed to be operated.

The data in FIG. 3 indicates that Li₃AlF₆ can be more densified than the conventional modified AlF₃ and can also have a higher ionic conductivity. Therefore, Li₃AlF₆ can be used at a higher concentration than the modified AlF₃ and thus can form a battery with a larger capacity. Moreover, the increase in the volume of Li₃AlF₆ with increasing concentration can be kept relatively low, which will make it possible to increase the content of a solid electrolyte including a fluoride ion-conducting fluoride material as described later and to increase the content of a conductive aid, so that higher ionic conductivity can be achieved.

The negative electrode according to the embodiment for use in a fluoride ion secondary battery preferably further includes a fluoride ion-conducting fluoride solid electrolyte and a conductive aid in addition to the Li₃AlF₆ as a negative electrode active material.

The fluoride ion-conducting fluoride may be any fluoride having fluoride ion conductivity. Examples of the fluoride ion-conducting fluoride include CeBaFₓ and BaLaF_{y}, such as Ce_{0.95}Ba_{0.05}F_{2.95} and Ba₀₆La_{0.4}F_{2.4}. When containing such a fluoride ion-conducting fluoride, the negative electrode according to the embodiment for use in a fluoride ion secondary battery can have improved fluoride ion conductivity.

The fluoride ion-conducting fluoride is preferably in the form of particles with an average particle size in the range of 0.1 μm to 100 μm. The fluoride ion-conducting fluoride in the form of particles with an average particle size in such a range can form an electrode thin layer having relatively high ionic conductivity. More preferably, the fluoride ion-conducting fluoride is in the form of particles with an average particle size in the range of 0.1 μm to 10 μm.

The conductive aid may be any type having electron conductivity. For example, the conductive aid may be carbon black or the like. The carbon black may be furnace black, Ketjen black, or acetylene black. When containing such a conductive aid, the negative electrode according to the embodiment for use in a fluoride ion secondary battery can have improved electron conductivity.

The conductive aid is preferably in the form of particles with an average particle size in the range of 20 nm to 50 nm. The conductive aid in the form of particles with an average particle size in such a range can form a lightweight electrode having high electron conductivity.

The negative electrode according to the embodiment for use in a fluoride ion secondary battery may further include additional components, such as a binder, as long as such components do not impair the advantageous effects of the embodiment.

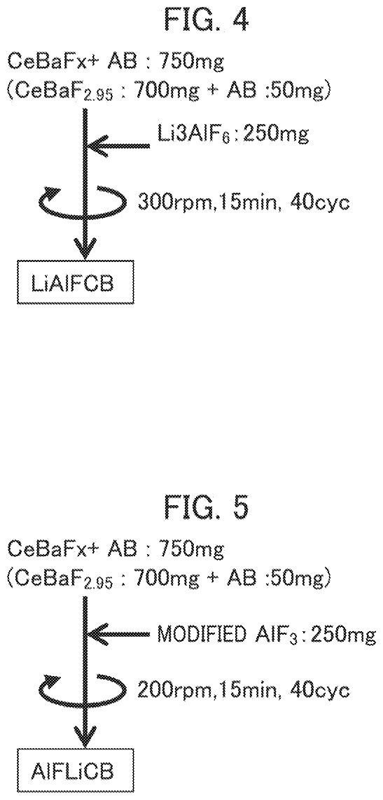

Next, methods for producing the negative electrode according to the embodiment for use in a fluoride ion secondary battery will be described in detail with reference to FIGS. 4 and 5. FIG. 4 is a diagram showing an exemplary method for producing the negative electrode according to the embodiment for use in a fluoride ion secondary battery. FIG. 5 is a diagram showing an exemplary method for producing a conventional negative electrode for use in a fluoride ion secondary battery. Specifically, FIG. 5 shows a method for producing a negative electrode using the modified AlF₃, which is a lithium metal-doped aluminum fluoride material as proposed in the conventional art.

In the exemplary production method shown in FIG. 4, first, a mixture is prepared of 700 mg of CeBaFₓ (Ce_{0.95}Ba_{0.05}F_{2.95}), which is a fluoride ion-conducting fluoride solid electrolyte, and 50 mg of carbon black (acetylene black AB), which is a conductive aid.

Subsequently, 250 mg of Li₃AlF₆ produced by the synthesis method shown in FIG. 1 is added to the mixture, and then the resulting mixture is subjected to, for example, 40 cycles of ball milling at 300 rpm for 15 minutes. As a result, a material mixture LiAlFCB is obtained which is for the negative electrode according to the embodiment for use in a fluoride ion secondary battery. The resulting material mixture LiAlFCB and a negative electrode current collector, such as a gold foil, are then integrated by pressing at a predetermined pressure to form a negative electrode according to the embodiment for use in a fluoride ion secondary battery.

In this process, Li₃AlF₆ and the fluoride ion-conducting fluoride may be mixed in any selected ratio. As mentioned above, the negative electrode for use in a fluoride ion secondary battery preferably has a Li₃AlF₆ content of 25F by mass or less. For an increase in charging capacity, the fluoride ion-conducting fluoride as a source of fluorine is preferably mixed in a higher ratio.

As is apparent from a comparison between FIGS. 4 and 5, the method for producing the negative electrode according to the embodiment and the method for producing the conventional negative electrode differ in the negative electrode active material added to the mixture of the fluoride ion-conducting fluoride and the conductive aid. In the method for producing the negative electrode according to the embodiment for use in a fluoride ion secondary battery, Li₃AlF₆ produced by the synthesis method described above is added as a negative electrode active material to form a mixture of the fluoride ion-conducting fluoride, the conductive aid, and Li₃AlF₆, which is a negative electrode material mixture for use in a fluoride ion secondary battery. The method and so on for producing the modified AlF₃, which is a lithium metal-doped aluminum fluoride material and added in the method for producing the conventional negative electrode for use in a fluoride ion secondary battery, are described in detail in PCT/JP2019/039886.

As mentioned above, Li₃AlF₆ for use as a negative electrode active material has an unstable crystal structure, which is destroyed and turned into an amorphous state by ball milling in the process shown in FIG. 4 for producing the negative electrode according to the embodiment for use in a fluoride ion secondary battery. This means that no specific peaks can be observed in the X-ray diffraction measurement of Li₃AlF₆ used as the negative electrode active material according to the embodiment. As a solution, NMR measurement may be used in place of the X-ray diffraction measurement. The NMR measurement enables the detection of Li₃AlF₆ existing in an amorphous state as the negative electrode active material according to the embodiment.

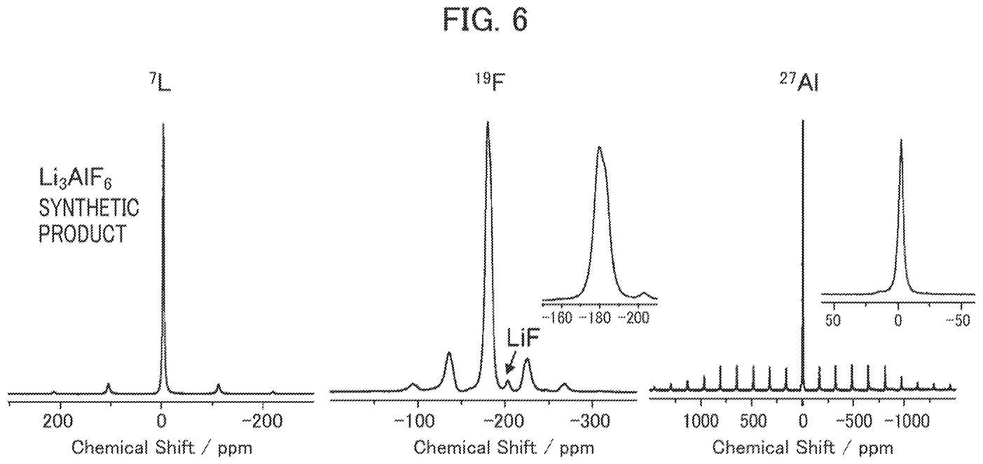

FIG. 6 is a graph showing an NMR spectrum of Li₃AlF₆ as the negative electrode active material according to the embodiment. More specifically, FIG. 6 shows a solid NMR spectrum of synthetic Li₃AlF₆ produced by the synthesis method shown in FIG. 1. The NMR measurement conditions are as shown below.

### NMR Measurement Conditions

NMR system: JNM-ECA 600 manufactured by JEOL Ltd.

Probe: 1.6 mm triple resonance Agilent MAS probe
Temperature: room temperature
Spin condition: 35 kHz
Standards: LiCl for ⁷Li, CFCl₃ for ¹⁹F, Al(NO₃)₃ for ²⁷Al

FIG. 6 shows that a large peak is observed at a chemical shift of 180 ppm in the NMR spectrum of the synthetic Li₃AlF₆. The large peak is identified as a ¹⁹F-derived peak characteristic of Li₃AlF₆. This shows that the solid NMR measurement enables the confirmation of the presence or absence of Li₃AlF₆ produced in an amorphous state by the method described above. The LiF peak observed in the NMR spectrum of the synthetic Li₃AlF₆ is derived from the unreacted LiF residue.

The negative electrode according to the embodiment described above for use in a fluoride ion secondary battery has advantageous effects as shown below.

The negative electrode according to the embodiment for use in a fluoride ion secondary battery includes Li₃AlF₆ as a negative electrode active material. As shown above, Li₃AlF₆ can be more densified than the modified AlF₃, which is a lithium metal-doped aluminum fluoride material, and can also have a higher ionic conductivity. Therefore, Li₃AlF₆ can be used at a higher concentration than the conventional modified AlF₃ and can form a battery with a larger capacity. Moreover, the increase in the volume of Li₃AlF₆ with increasing concentration can be kept relatively low, which will make it possible to increase the content of a solid electrolyte including a fluoride ion-conducting fluoride and to increase the content of a conductive aid, so that higher ionic conductivity can be achieved and that a battery with a larger capacity can be provided.

For a fluoride ion secondary battery, the negative electrode according to the embodiment can also have a high level of active material utilization for the first charge and discharge cycle and have a high coulombic efficiency. Specifically, the Li₃AlF₆ according to the embodiment has an active material utilization as high as about 70% and a coulombic efficiency as high as about 80%, whereas the conventional modified AlF₃ has an active material utilization as low as about 40% and a coulombic efficiency as low as about 50%.

### Fluoride Ion Secondary Battery

The fluoride ion secondary battery according to an embodiment of the present invention includes the negative electrode described above. The fluoride ion secondary battery according to the embodiment also includes a solid electrolyte layer including a fluoride ion-conducting solid electrolyte; and a positive electrode.

The solid electrolyte as a component of the solid electrolyte layer may be a conventionally known solid electrolyte. Specifically, the solid electrolyte may be a fluoride ion-conducting fluoride as described above.

The positive electrode may include a conventionally known positive electrode active material. The positive electrode preferably has a standard electrode potential sufficiently higher than that of the negative electrode according to the embodiment. A fluoride ion-free material may be selected as a positive electrode material to form a battery that can be charged at the start. In this case, the battery can be produced in a discharged state at a low energy level with improved stability of the active material in the electrode.

Examples of the positive electrode material include Pb, Cu, Sri, Bi, Ag, a conductive aid, and a binder. For example, a positive electrode material mixture including lead fluoride or tin fluoride and carbon black may be integrated with a positive electrode material for serving as a current collector, such as a lead foil, by pressing at a predetermined pressure to form a positive electrode.

Thus, the negative electrode according to the embodiment, the solid electrolyte layer, and the positive electrode may be stacked in order to form the fluoride ion secondary battery according to the embodiment. The fluoride ion secondary battery according to the embodiment can produce the same advantageous effects as shown for the negative electrode according to the embodiment described above.

The embodiments described above are not intended to limit the present invention and may be altered or modified within the scope of the invention where the objects of the present invention can be achieved. For example, while embodiments in which the present invention is applied to solid-state batteries have been described, such embodiments are not intended to limit the battery type. The present invention may also be applied to fluoride ion secondary batteries including an electrolytic solution in place of the solid electrolyte layer.

### EXAMPLES

Next, examples of the present invention will be described, which are not intended to limit the scope of the present invention.

### Examples 1 and 2

In each of Examples 1 and 2, a negative electrode for use in a fluoride ion secondary battery was prepared according to the method shown in FIG. 4 for producing the negative electrode according to the embodiment. Li₃AlF₆ in the form of particles with an average particle size on the order of micrometers (10 μm to 100 μm), a fluoride ion-conducting fluoride in the form of particles with an average particle size of 0.1 to 100 μm, and a conductive aid in the form of particles with an average particle size of 20 to 50 nm were used in each of Examples 1 and 2. The content of Li₃AlF₆ in the negative electrode for use in a fluoride ion secondary battery was 12.5% by mass in Example 1 and 25% by mass in Example 2.

### Comparative Examples 1 and 2

In each of Comparative Examples 1 and 2, a negative electrode for use in a fluoride ion secondary battery was prepared using the synthesis method described in PCT/JP2019/039886 and the method shown in FIG. 5 for producing the conventional negative electrode for use in a fluoride ion secondary battery. Modified AlF₃ in the form of particles with an average particle size on the order of nanometers was used in all of Comparative Examples 1 and 2. The content of the modified AlF₃ in the negative electrode for use in a fluoride ion secondary battery was 12.5% by mass in Comparative Example 1 and 251 by mass in Comparative Example 2.

### Charge and Discharge Test

The negative electrode prepared in each of the examples was used to form a half cell. The resulting half cells were subjected to a charge and discharge test at a constant current. Specifically, the constant-current charge and discharge test on the half cell having the negative electrode with the active material content of 12.5% by mass was carried out in a vacuum environment at 140° C. at a charging current of 0.02 mA and a discharging current of 0.01 mA with a lower limit voltage of −2.35 V and an upper limit voltage of −0.1 V using a potentio-galvanostat system (SI 1287/1255B manufactured by Solartron). The test was started from the application of the charging current. The constant-current charge and discharge test on the half cell having the negative electrode with the active material content of 25% by mass was carried out in a vacuum environment at 140° C. at a charging current of 0.04 mA and a discharging current of 0.02 mA with a lower limit voltage of −2.44 V and an upper limit voltage of −0.1 V using a potentio-galvanostat system (SI 1287/1255B manufactured by Solartron). The test was started from the application of the charging current.

Each half cell was prepared in the form of a cylindrical columnar pellet cell by press-molding the materials at a pressure of 40 MPa in a tablet molding machine. Specifically, a gold foil (99.99%, 10 μm in thickness, manufactured by The Nilaco Corporation) as a negative electrode current collector, 10 mg of the negative electrode material mixture powder prepared in each of the examples, 200 mg of a solid electrolyte, 30 mg of a positive electrode material mixture powder, and a lead foil (99.99%, 200 μm in thickness, manufactured by the Nilaco Corporation) serving as a positive electrode material and a positive electrode current collector were placed in order in the tablet molding machine and then press-molded to form a half cell.

### Results and Discussion

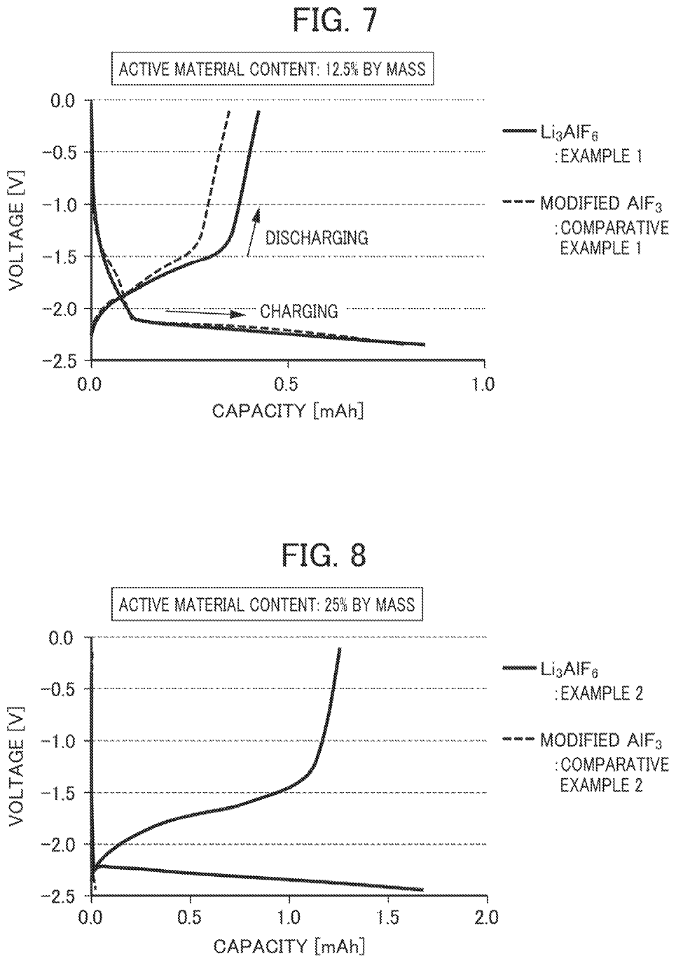

FIG. 7 is a graph showing the charging and discharging curves of the negative electrode half cells of Example 1 and Comparative Example 1 for fluoride ion secondary batteries. More specifically, FIG. 7 shows the charging and discharging curves of the half cells of Example 1 and Comparative Example 1 at the first charge and discharge cycle. FIG. 7 indicates that the half cell of Example 1 having the negative electrode with the Li₃AlF₆ content of 12.5% by mass has a charging capacity substantially the same as that of the half cell of Comparative Example 1 having the negative electrode with the modified AlF₃ content of 12.5% by mass. Meanwhile, the half cell of Example 1 was found to have a discharging capacity larger than that of the half cell of Comparative Example 1, which indicates that the half-cell of Example 1 has a coulombic efficiency (the ratio of discharging capacity to charging capacity) higher than that of the half-cell of Comparative Example 1. The result shows that the example according to the present invention can improve the reversibility of charging and discharging as compared to the conventional example.

FIG. 8 is a graph showing the charging and discharging curves of the negative electrode half cells of Example 2 and Comparative Example 2 for fluoride ion secondary batteries. More specifically, FIG. 8 shows the charging and discharging curves of the half cells of Example 2 and Comparative Example 2 at the first charge and discharge cycle. FIG. 8 indicates that the half cell of Comparative Example 2 having the negative electrode with the modified AlF₃ content of 25% by mass has almost no charging or discharging capacity. In contrast, the half cell of Example 2 having the negative electrode with the Li₃AlF₆ content of 25% by mass was found to have large charging and discharging capacities. The result shows that the Li₃AlF₆ content of the negative electrode according to the example for use in a fluoride ion secondary battery can be increased to 25% by mass so that a battery capacity larger than that of the conventional one can be obtained.

The actually available capacity is expressed by the active material utilization rate relative to the theoretical capacity. In this regard, while Li₃AlF₆ has a theoretical capacity of 2.48 mAh, FIG. 8 shows the result that Example 2 provides a capacity of about 1.7 mAh, which shows that an active material utilization as high as about 68% can be achieved according to Example 2. FIG. 8 also shows the result that Example 2 provides a discharging capacity of about 1.3 mAh for the charging capacity of about 1.7 mAh, which shows that a coulombic efficiency as high as about 80% can be achieved.

What is claimed is:

1. A negative electrode for use in a fluoride ion secondary battery, the negative electrode comprising a negative electrode active material including Li₃AlF₆.

2. The negative electrode according to claim 1, having a Li₃AlF₆ content of 25% by mass or less.

3. The negative electrode according to claim 1, wherein the Li₃AlF₆ is in an amorphous state.

4. The negative electrode according to claim 1, wherein the Li₃AlF₆ is in the form of particles with an average particle size on the order of micrometers.

5. A fluoride ion secondary battery comprising the negative electrode according to claim 1.
